(19) United States
(12) Patent Application Publication
(10) Pub. No.: US 2011/0294933 A1
(43) Pub. Date: Dec. 1, 2011

(54) POLYHYDROXYFUNCTIONAL POLYSILOXANES FOR INCREASING THE SURFACE ENERGY OF THERMOPLASTICS, METHOD FOR PRODUCTION AND USE THEREOF

(75) Inventors: Wojciech Jaunky, Wesel (DE); Barbel Gertzen, Emmerich (DE); Albert Frank, Xanten (DE); Hans-Willi Bogershausen, Tonisvorst (DE); Alfred Bubat, Wesel (DE); Jurgen Omeis, Dorsten-Lembeck (DE)

(73) Assignee: BYK-Chemie GmbH, Wesel (DE)

(21) Appl. No.: 13/002,720

(22) PCT Filed: Jul. 6, 2009
(86) PCT No.: PCT/EP09/04867

§ 371 Date: Apr. 28, 2011

(30) Foreign Application Priority Data
Jul. 8, 2008 (DE) 10 2008 032 064.1

(51) Int. Cl. C08K 5/5419; C07F 7/08; C08L 27/06; C08L 55/02; C08L 23/06; C08L 23/10

(52) U.S. Cl. 524/265; 524/731; 556/456

(57) ABSTRACT

The invention relates to polyhydroxyfunctional polysiloxanes, which may be produced by the addition of at least one branched polyhydroxyfunctional allyl polyether to a Si—H functional alkyl polysiloxane, to methods for production thereof and the use thereof as additives in thermoplastics and polymeric moulded masses and the thermoplastics and polymeric moulded masses containing the same.

The present invention relates to the use of polyhydroxyfunctional polysiloxanes which can be prepared by the addition reaction of polyhydroxyfunctional allyl polyethers onto alkyl-hydrogen siloxanes as additives for increasing the surface energy and for improving the printability of thermoplastics and polymeric molding compositions. The invention further relates to a method for increasing the surface energy of thermoplastics and polymeric molding compositions, and to thermoplastics and polymeric molding compositions comprising the polyhydroxyfunctional polysiloxanes.

For reasons of environmental protection (e.g. for reducing the emission of volatile organic compounds), it is extremely desirable to switch from solvent-containing paint systems to water-based coating systems. Most thermoplastic polymers have a nonpolar, highly electrically insulating and water-repelling surface with a low surface energy. Consequently, wetting such surfaces by e.g. printing inks, aqueous polymer dispersions, adhesives or adhesion promoters is a challenge. In order to improve the wetting of printing inks or paint formulations on thermoplastic substrates, the surface has to be made more polar through modification. For this reason, there is a need to develop corresponding methods for improving the printability/paintability of various thermoplastic materials and polymeric molding compositions.

The current practice in industry for increasing the polarity of such surfaces is the oxidation of surfaces by e.g. flame treatment or corona treatment. This treatment then ideally leads to improved adhesion.

Moreover, the effectiveness and the permanence of such methods is not satisfactory. In addition, molded thermoplastic articles with a complex 3D geometry cannot be treated efficiently.

The effect of the polarization of such surfaces, which brings about an increase in the affinity towards water-based formulations, is not permanent. After a certain storage time of the treated surfaces, the surface energy is reduced again. In these cases, the surface has to be subjected to another treatment prior to coating.

It is therefore an aim of the present invention to provide an additive which increases the surface energy of thermoplastic materials. It is a further aim of the present invention to provide a method for increasing the surface energy of thermoplastic materials. It is a further aim of the present invention to provide a formulation for increasing the surface energy of thermoplastic materials which can be printed or coated immediately or following storage and which do not have to be further pretreated before the final coating step.

Surprisingly, it has been found that materials with increased surface energy result from the addition of polyhydroxyfunctional polyether-modified polysiloxanes to thermoplastics or polymeric molding compositions.

The method involves the mixing of small amounts of polyhydroxyfunctional polyether-modified polysiloxanes with very different low-, medium- and high-density thermoplastic materials of varying polarities or such polymeric molding compositions for modifying the surface energy. The thermoplastic substrates and polymeric molding compositions obtained in this way can be coated with aqueous printing inks or paints. The resulting coatings have improved adhesion.

Polyhydroxyfunctional polyether-modified polysiloxanes are known in principle from numerous patent specifications.

U.S. Pat. No. 4,431,789 describes the preparation of organosiloxanes with alcoholic hydroxy groups. The compounds are prepared by the hydrosilylation of methyl-hydrogen siloxanes and polyglycerols which have a terminal allyl group. The compounds obtained in this way can be used as nonionic surface-active polysiloxanes.

JP 10316540 describes as hair conditioning agents reaction products of methyl-hydrogen siloxanes and allyl polyglycerols which are very similar to those in U.S. Pat. No. 4,431,789.

US 2006/0034875 describes the synthesis of polyglycerol-modified polysiloxanes for use as emulsifiers. These emulsifiers are suitable for storing oils through incorporation with swelling in cosmetic preparations.

EP 1 489 128 describes the synthesis of polysiloxanes modified with polyglycerol and their application in fabrics and cosmetic formulations. Claimed advantages are improved wetting and absorption on various substrates, lower yellowing and skin irritation.

US 2005/0261133 discloses the preparation and use of glycerol-modified polysiloxanes as spreading agents for chemical crop protection formulations. The disclosed products reduce the surface tension of crop protection compositions in order to improve the spreading of pesticides and insecticides on leaf surfaces.

WO 2007/075927 describes branched polyether-modified polysiloxanes as additives for coatings which improve the hydrophilicity and the soiling tendency of coatings. The branched polyethers are based on oxetanes, glycidol and/or alkylene oxides.

DE 10 2006 031 152 discloses branched polyhydroxyfunctional polysiloxanes which can be prepared by the addition of hydroxyoxetane-based polyhydroxyfunctional allyl polyethers onto alkyl-hydrogen siloxanes. The disclosed products are described for increasing the hydrophobic and oleophobic properties of coating surfaces, and also for improving separation properties in polymeric molding compositions.

WO 2008/003470 describes the use of polyhydroxyfunctional polysiloxanes in thermoplastics for improving the soil-repellant and anti-adhesive properties of the thermoplastic. The polysiloxanes are obtained via additional reactions of hydroxyoxetane derivatives. WO 2008/003470 gives no indication that certain polysiloxanes can also be used for improving the printability. On the contrary, the thermoplasts obtained in WO 2008/003470 are particularly soil-repellant and anti-adhesive.

The use of additives for the hydrophilization of polyolefin surfaces, such as e.g. polypropylene, has already been described, see “Zhu, S, and Hirt, D. E., Hydrophilization of Polypropylene Films Using Migratory Additives, Journal of Vinyl and Additive Technology, (2007), 13(2), 57-64”. The surface-modified additives described herein include linear polyethylene glycols and branched hydroxy-terminal 4-arm polyethylene glycols. There was no significant improvement in surface hydrophilicity with the linear polyethylene glycols and the branched hydroxy-terminal 4-arm polyethylene glycols. However, the study revealed that the commercial product IRGASURF HL 560 (CIBA Specialty Chemical) changes the surface wettability in a relatively short time.

Moreover, the patent literature describes fatty alcohols and fatty acid derivatives of polyethylene glycols for increasing the surface energy of polyolefins (e.g. U.S. Pat. No. 5,464,691; U.S. Pat. No. 5,240,985; U.S. Pat. No. 5,271,991; U.S. Pat. No. 5,272,196; U.S. Pat. No. 5,281,438; U.S. Pat. No. 5,328,951; U.S. Pat. No. 5,001,015).

Although other additives have also been described which increase the surface energy of thermoplastics, there is a need for substances which are effective in a smaller amount, which can be used in a large number of thermoplastics and polymeric molding compositions, especially in thermoplastics with a relatively high fraction of crystalline zones, and which do not have a negative effect on the processability and mechanical or optical properties of the additive/thermoplastic mixtures.

The object of the present invention relates to increasing the surface energy of thermoplastics.

In particular, the object was to provide thermoplastics which exhibit improved printability, paintability and adhesion of water-based formulations. Furthermore, additives added to impart these improved properties should, as far as possible, not adversely affect the other properties of the thermoplastics. Moreover, the added additives should be able to develop their effectiveness in relatively small amounts.

Surprisingly, it has been found that the objects described above can be achieved through the use of a polyether-modified polyhydroxyfunctional polysiloxane preparable by

i) firstly reacting at least one (meth)allylic starter compound having at least one hydrogen-active group with at least one reagent selected from the group consisting of glycidol, glycerol carbonate and hydroxyoxetanes such that, with ring opening, at least one (meth)allyl polyether is formed which comprises at least one branched polyglycidol radical and/or at least one branched polyoxetane radical, and then
ii) adding the (meth)allyl polyether(s) obtained in the presence of an acid-buffering agent onto an Si—H-functional alkylpolysiloxane,
as additive in thermoplastics or polymeric molding compositions.

Thermoplastics and polymeric molding compositions to which these addition products are added are characterized by high surface energies and an improved printability compared to thermoplastics or polymeric molding compositions to which such addition products have not been added. The addition products according to the invention also do not significantly impair the other properties of the thermoplastics. Here, these polyhydroxyfunctional polysiloxanes can be added to the thermoplastics in relatively small amounts (additive amounts). The physical properties of the original thermoplastics, for example with regard to the mechanical and optical properties, the weathering resistance and processability, are not adversely affected by the low concentrations of the additive. Moreover, the thermoplastics and polymeric molding compositions which comprise the addition products according to the invention exhibit additional typical properties which result from the increase in surface energy, such as e.g. antistatic properties.

The method according to the invention for increasing the surface energy of thermoplastics and polymeric molding compositions involves the mixing of small amounts of polyhydroxyfunctional polyether-modified polysiloxanes with very different polymeric molding compositions and/or low-, medium- and high-density thermoplastic materials with different crystallinities and polarities for the homogeneous modification of the surface energy. In order to achieve the surface modifications mentioned above, the polyhydroxyfunctional polyether-modified polysiloxanes distributed within the thermoplastic material or polymeric molding compositions segregate to the surface of the thermoplastic material thus mixed in order to hydrophilize it.

The polyhydroxyfunctional polysiloxane which can be used according to the invention for improving the printability of thermoplastics and polymeric molding compositions is preparable via the addition of at least one branched polyhydroxyfunctional allyl polyether on to an Si—H-functional polysiloxane. The expression “branched polyether” here stands for a polyether in which the main chain and at least one side chain contains polyether bridges. Preferably, this branched polyether has a hyperbranched structure. The branches can be detected for example by NMR analysis.

The Si—H-functional polysiloxane may be a chain polymer, a cyclic polymer, a branched polymer or a crosslinked polymer. It is preferably a chain polymer or a branched polymer. It is particularly preferably a chain polymer. The Si—H-functional alkylpolysiloxane is preferably an alkyl-hydrogen polysiloxane substituted with corresponding C₁-C₁₄-alkylene, -arylene or arylalkylene. Preferably, the alkyl-hydrogen polysiloxane is a methyl-hydrogen polysiloxane.

A preferred subject matter of the invention is the use of polyhydroxyfunctional chain-like polysiloxanes which can be represented by the following general formula (I):

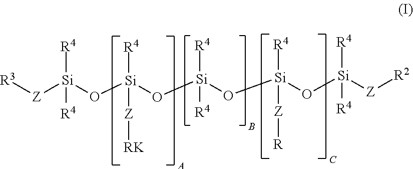

where
Z=independently of one another, C₁-C₆-alkylene, where substituents Z bonded to the radicals R or RK are, independently of one another, C₃-C₆-alkylene, preferably propylene,
RK=unbranched polyether radical of alkylene oxide units and/or arylene oxide units, and/or aliphatic radical and/or cycloaliphatic radical, and/or unbranched and aliphatic, cycloaliphatic and/or aromatic polyester radical
R=polyhydroxyfunctional branched polyglycidol polyether radical which consists of a branched polyglycidol group or comprises this, and/or
   =polyhydroxyfunctional branched polyoxetane polyether radical which consists of a branched polyoxetane group or comprises this,
R² and R³, independently of one another, are C₁-C₁₄-alkyl, -aryl or -aralkyl, —O(C₁-C₁₄-alkyl, -aryl or -aralkyl), —OCO(C₁-C₁₄-alkyl, -aryl or -aralkyl), —O—CO—O(C₁-C₁₄-alkyl, -aryl or aralkyl), —H, —OH, —R, —RK,
R₄=C₁-C₁₄-alkyl, -aryl or -aralkyl,
A=0-4, preferably 0-2, particularly preferably 0 or 1, very particularly preferably 0,
B=0-6, preferably 0-4, particularly preferably 0, 1 or 2, very particularly preferably 0 or 1, and
C=0-6, preferably 1-4, particularly preferably 1 or 2;
   where the sum of A+B+C is at most 7, and
   where when C=0, R³=R and/or R²=R.
   If the unit —[SIR⁴(Z—R)]—O— is present, i.e. C is at least 1, then it is possible for R² and R³ to be different from R.

Compounds of the general formula (I) in which A is at least 1 are advantageously used in those systems which require a compatibility adaptation.

The copolymers corresponding to the structural formula given above may be random copolymers, alternating copolymers or block copolymers. A gradient may also be formed by the sequence of the side chains along the silicone backbone. The A units of the formula —[SiR⁴(Z—RK)]—O—, the B units —Si(R⁴)₂—O— and the C units —[SiR⁴(Z—R)]—O— can be arranged in the polysiloxane chain in any desired order.

The chain-like polyhydroxyfunctional polysiloxanes consist, as can be deduced from the structure of the formula (I) and the corresponding definitions of A, B and C, from 2 to 9 siloxane units. Preferably, the chain-like polyhydroxyfunctional polysiloxanes according to the invention consist of 3 to 7 siloxane units, particularly preferably of 3-4 siloxane units and very particularly preferably of 3 siloxane units.

In order to introduce the polyhydroxyfunctional branched polyether alkyl radical —Z—R into the Si—H-functional polysiloxane, a branched polyhydroxyfunctional (meth)allyl polyether is preferably used which can be prepared by ring-opening polymerization of glycidol or hydroxy oxetanes with one or more (meth)allylic starter compounds carrying hydroxy groups. These branched polyhydroxyfunctional (meth)allyl polyethers can be introduced into the polysiloxane by means of addition. They usually have exactly one (meth)allyl group, i.e. they are mono(meth)allylic and thus do not act as crosslinkers or linkers between two or more Si—H-functional polysiloxanes.

The (meth)allylic starter compounds have at least one hydrogen-active group. Hydrogen-active groups are understood as meaning those functional groups which carry an active hydrogen atom bonded to a heteroatom, such as, for example, hydroxy groups (—OH), amino groups (—NH₂), aminoalkyl groups (—NH(alkyl)) or thiol groups (—SH).

Preference is given to using monohydroxyfunctional allylic starter compounds from the group consisting of allyl alcohol, ethylene glycol monoallyl ether, allyl polyethylene glycol, allyl polypropylene glycol, allyl polyethylene/polypropylene glycol mixed polymers, where ethylene oxide and propylene oxide may be arranged in random structure or blockwise.

The monohydroxyfunctional allylic starter compounds used are particularly preferably allyl alcohol, ethylene glycol monoallyl ether and allyl polyethylene glycol. Very particular preference is given to allyl alcohol and ethylene glycol monoallyl ether.

The corresponding methallyl compounds can also be used, such as e.g. methallyl alcohol, methallyl polyethylene glycol, etc. Wherever the term allylic starter compounds is discussed within the context of this invention, it also includes the methallylic analogs without these having to be discussed separately. If the term “(meth)allylic” is used, then this likewise includes “allylic” and also “methallylic”.

Other mono-hydroxyfunctional allylic and methallylic starter compounds, such as e.g. allylphenyl, can also be used. Further possibilities are the use of (meth)allylic starter compounds with hydrogen-active groups other than the hydroxy group, such as e.g. amino-(—NH₂, —NH(alkyl)) or thiol derivatives.

Di-, tri- or polyfunctional starter compounds can also be used which exhibit advantages with regard to the polydispersity and some physical properties. The hydroxy groups of the di- or polyfunctional monoallylic starter compound are preferably etherified with a di-, tri- or polyol, for example a dihydroxy, trihydroxy or polyhydroxy ester or polyester or a dihydroxy, trihydroxy or polyhydroxy ether or polyether, such as, for example, a 5,5-dihydroxyalkyl-1,3-dioxane, a 5,5-di(hydroxyalkoxy)-1,3-dioxane, a 5,5-di(hydroxyalkoxyalkyl)-1,3-dioxane, a 2-alkyl-1,3-propanediol, a 2,2-dialkyl-1,3-propanediol, a 2-hydroxy-1,3-propanediol, a 2,2-dihydroxy-1,3-propanediol, a 2-hydroxy-2-alkyl-1,3-propanediol, a 2-hydroxyalkyl-2-alkyl-1,3-propanediol, a 2,2-di(hydroxyalkyl)-1,3-propanediol, a 2-hydroxyalkoxy-2-alkyl-1,3-propanediol, a 2,2-di(hydroxyalkoxy)-1,3-propanediol, a 2-hydroxyalkoxyalkyl-2-alkyl-1,3-propanediol or a 2,2-di(hydroxyalkoxyalkyl)-1,3-propanediol.

Preferred embodiments of the specified di- or polyfunctional monoallylic starter compound are etherified with dimers, trimers or polymers of 5,5-dihydroxyalkyl-1,3-dioxanes, 5,5-di(hydroxyalkoxy)-1,3-dioxanes, 5,5-di(hydroxyalkoxyalkyl)-1,3-dioxanes, 2-alkyl-1,3-propanediols, 2,2-dialkyl-1,3-propanediols, 2-hydroxy-1,3-propanediols, 2,2-dihydroxy-1,3-propane-diols, 2-hydroxy-2-alkyl-1,3-propanediols, 2-hydroxy-alkyl-2-alkyl-1,3-propanediols, 2,2-di(hydroxyalkyl)-1,3-propanediols, 2-hydroxyalkoxy-2-alkyl-1,3-propane-diols, 2,2-di(hydroxyalkoxy)-1,3-propanediols, 2-hydroxyalkoxyalkyl-2-alkyl-1,3-propanediols and 2,2-di(hydroxyalkoxyalkyl)-1,3-propanediols.

The specified alkyl radicals are preferably linear or branched C₁-C₂₄-, such as for example C₁-C₁₂- or C₁-C₈-, -alkyls or -alkenyls. Particularly preferred alkyl radicals are methyl and ethyl radicals. The expression “alkoxy” is preferably methoxy, ethoxy, propoxy, butoxy, phenylethoxy and comprises up to 20 alkoxy units or a combination of two or more alkoxy units.

Further preferred embodiments of the allylic starter compound with at least two hydroxyl groups include monoallyl ethers or monomethallyl ethers of glycerol, of trimethylolethane and trimethylolpropane, monoallyl or mono(methallyl)ethers of di(trimethylol)ethane, di(trimethylol)propane and pentaerythritol and also of 1,Ω-diols, such as, for example, mono-, di-, tri- and polyethylene glycols, mono-, di-, tri- and polypropylene glycols, 1,4-butanediol, 1,5-pentanediol, 1,6-hexanediol, 1,6-cyclohexanedimethanol and their correspondingly alkyl-, alkylalkoxy- and alkoxyalkyl-substituted analogs, and also derivatives thereof. The terms “alkyl” and “alkoxy” correspond here to the definitions specified above.

The allylic starter compound having at least two hydroxy compounds is particularly preferably derived from a compound from the group consisting of 5,5-dihydroxymethyl-1,3-dioxane, 2-methyl-1,3-propanediol, 2-methyl-2-ethyl-1,3-propanediol, 2-ethyl-2-butyl-1,3-propanediol, neopentyl glycol, dimethylpropane, glycerol, trimethylolethane, trimethylolpropane, diglycerol, di(trimethylolethane), di(trimethylol-propane), pentaerythritol, di(pentaerythritol), anhydroenneaheptitol, sorbitol and mannitol.

For the polymerization of the branched allylic polyethers, particular preference is given to using allylic starter compounds with two hydroxy groups, such as, for example, trimethylolpropane monoallyl ether or glycerol monoallyl ether.

The ring-opening polymerization with glycidol or with mixtures of glycidol with glycidyl ethers and/or with alkylene oxides takes place over such allylic starter compounds. Here, the polymerization of the mixtures of glycidol with glycidyl ethers and/or with alkylene oxides can be carried out in random structure or blockwise. The glycidyl ethers may be alkyl- or polyalkylene oxide-substituted.

The expression “alkyl-substituted” here preferably stands for a substitution with linear or branched C₁-C₂₄-, such as, for example, C₁-C₁₂- or C₁-C₈-alkylene or -alkenylene. The expression “alkyl-substituted” particularly preferably stands for a substitution with methyl, ethyl, propyl and/or butyl. The expression “polyalkylene oxide-substituted” stands for a combination of two or more alkylene oxide units, preferably for a substitution with polyethylene oxide units, polypropylene oxide units and/or polybutylene oxide units.

Glycidol is preferably used as main monomer. This means that preferably at least 50 mol %, particularly preferably at least 70 mol % and very particularly preferably at least 90 mol %, of the radical R is composed of glycidol radicals.

The allyl-functional hyperbranched polyglycidol can be synthesized via a ring-opening polymerization process. In order to obtain well defined structures, an anionic ring-opening polymerization with the slow addition of monomer is particularly preferably carried out.

Preferably, the following method is used: the hydroxy groups of the allyl-functional initiator are partially deprotonated by alkali metal hydroxides or alkoxides, and after removing the water or alcohol by distillation, a mixture of initiator and initiator-alcoholate is obtained. The glycidol is then added dropwise to the initiator/initiator-alcoholate mixture at a temperature between 80° C. and 100° C. The living anionic ring-opening polymerization is controlled by the rapid exchange of the protons between the alcohol groups and alcoholate groups of the growing chains.

After the reaction, the alkali is removed e.g. through treatment with an acidic ion exchanger. Further details relating to reactions, reactants and procedures can be found in the following publications:
Sunder A, Hanselmann R, Frey H, Müllhaupt R:. Macromolecules 1999; 32:4240-6
EP1785410 (polyglycerol monoethers and process for producing the same)
US2003/0120022 (Method for producing highly-branched glycidol-based polyols)

The hydroxy groups can remain free or can be partially or completely modified in order to be able to establish the optimum compatibility in the application formulation.

The polyhydroxyfunctional allyl compounds have at least one branching generation, preferably at least two branching generations. The expression “generation” is here used, like in WO 02/40572, for describing pseudo-generations. The branches can be detected for example by NMR analysis. The polydispersity (M_{w}/Mₙ) of the branched allyl compounds is <3, preferably <2 and particularly preferably <1.5.

The following formula (II) shows a preferably obtained dendrimeric reaction product, being obtained from the ethylene glycol monoallyl ether and glycidol in three generations. However, the resulting products are in reality at best described as pseudo-dendrimers or hyperbranched allyl-functional polyglycidols.

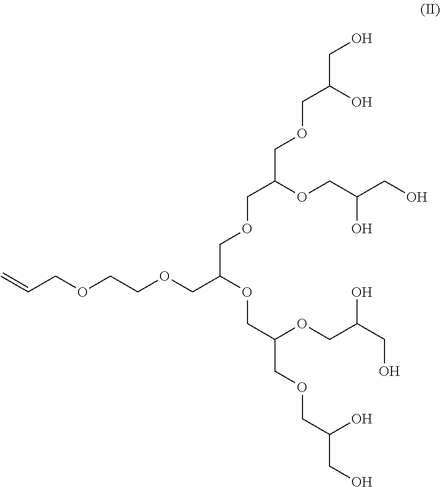

The synthesis of the polyhydroxyfunctional polysiloxanes preferably takes place via an addition of the allyl polyethers obtained by reacting the allylic starter compound with at least one glycidol onto the Si—H-functional alkylpolysiloxane.

The glycidol can be replaced by glycerol carbonate. The synthesis of glycerol carbonate and the reaction conditions under which these are reacted to give hyperbranched polyglycidols are known to the person skilled in the art for example from Rokicki et al. in: Green Chemistry, 2005, 7, 529-539.

Whenever hyperbranched polyglycidols are under discussion herein, then these may generally be obtained by ring-opening polymerization of either glycidol or glycerol carbonate. If reference is made herein to a ring-opening polymerization of glycidol, then this generally also includes the variant in which glycerol carbonate is reacted in a ring-opening manner, the person skilled in the art, if appropriate, adapting the reaction conditions to those described in Rockicki et al. (supra).

In a more environmentally friendly embodiment of the present invention, glycerol carbonate is used for producing the hyperbranched polyglycidol structures. Glycerol carbonate can be produced in a more environmentally compatible manner than glycidol and, according to current findings, does not have the carcinogenity of glycidol.

In order to introduce the polyhydroxyfunctional branched polyether alkyl radical —Z—R into the Si—H functional polysiloxane, use is also made of polyhydroxyfunctional dendritic allyl polyethers which can be prepared by ring-opening polymerization of hydroxyoxetanes, i.e. compounds with one oxetane group and at least one hydroxy group or hydroxyalkyl group, with one or more allylic starter compounds carrying hydroxy groups. These branched polyhydroxyfunctional allyl polyethers can be introduced into the polysiloxane by addition.

The ring-opening cationic polymerization with hydroxyoxetanes takes place over allylic starter compounds of this type, which have already been described in detail above. These hydroxyoxetanes may be alkyl- or hydroxyalkyl-substituted. The hydroxyoxetanes used according to the invention are preferably at least one 3-alkyl-3-(hydroxyalkyl)oxetane, a 3,3-di(hydroxyalkyl)oxetane, a 3-alkyl-3-(hydroxyalkoxy)oxetane, a 3-alkyl-3-(hydroxyalkoxyalkyl)oxetane or a dimer, trimer or polymer of a 3-alkyl-3-(hydroxyalkyl)oxetane, of a 3,3-di(hydroxyalkyl)oxetane, of a 3-alkyl-3-(hydroxy-alkoxy)oxetane or of a 3-alkyl-3-(hydroxy-alkoxyalkyl)oxetane. “Alkyl” here is preferably linear or branched C₁-C₂₄-, such as, for example, C₁-C₁₂— or C₁-C₈-, -alkyls or -alkenyls. The expression “alkyl” is particularly preferably methyl and ethyl. The expression “alkoxy” is preferably methoxy, ethoxy, propoxy, butoxy, phenylethoxy and contains up to 20 alkoxy units or a combination of two or more alkoxy units.

As hydroxyoxetane, particular preference is given to using at least one hydroxyoxetane selected from the group consisting of 3-methyl-3-(hydroxymethyl)oxetane, 3-ethyl-3-(hydroxymethyl)oxetane, 3,3-di(hydroxy-methyl)oxetane (trimethylolpropane oxetane). It is also possible to use mixtures of these compounds.

Further details relating to reactions, reactants and procedures are described inter alia in WO 02/40572.

The polyhydroxyfunctional dendritic allyl compounds based on the ring-opening polymerization of hydroxyoxetanes have at least one branching generation, preferably one to two branching generations. The expression “generation” is, like in WO 02/40572, in the present case also used for describing pseudo-generations. The branches can be detected for example by NMR analysis. The polydispersity of the dendritic allyl compounds is preferably <2.8, particularly preferably <1.7.

The following formula (III) shows a preferably obtained dendrimer-like reaction product which can be obtained from trimethylolpropane monoallyl ether and ethoxylated tirmethylolpropane oxetane in first generation. As can be seen from the formula, a dendrimer of first pseudo-generation is formed.

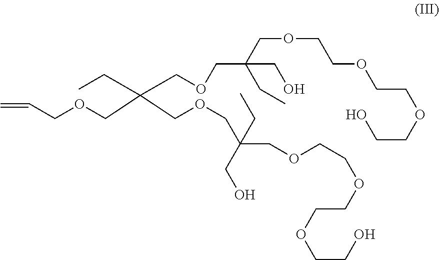

The polyhydroxyfunctional polysiloxanes can be prepared by reacting at least one allylic starter compound with at least one oxetane and subsequent addition onto the Si—H-functional alkylpolysiloxane. Preference is given to a reaction of the at least one allylic starter compound with at least one oxetane and subsequent addition onto the Si—H-functional alkylpolysiloxane.

The polyhydroxyfunctional allyl polyethers, obtained with ring-opening polymerization of glycidol and/or of hydroxyoxetanes, can have different average numbers of hydroxy groups in the molecule. Preferably, the polyhydroxyfunctional allyl polyethers have an average number of 2-10 hydroxy groups per molecule.

To establish better compatibility of the polyhydroxyfunctional polysiloxanes produced from these polyhydroxyfunctional allyl polyethers, the free hydroxy groups of the allyl polyethers can also be alkoxylated with the Si—H-functional polysiloxane before or after the hydrosilylation reaction. They are preferably ethoxylated and/or propoxylated and/or butoxylated and/or alkoxylated with styrene oxide. Here, it is possible to produce straight alkoxylates or mixed alkoxylates. The free hydroxy groups of the allyl polyethers are particularly preferably ethoxylated.

Furthermore, apart from an alkoxylation, the free hydroxy groups can also be chemically modified in another way. By way of example, mention may be made of methylation, acrylation, acetylation, esterification and conversion to the urethane by reaction with isocyanates. One example of the latter reaction is the conversion of the hydroxy groups with e.g. TDI monoadducts, which can be synthesized by reacting polyether monools with TDI (toluene diisocyanate).

All other known modification possibilities of hydroxy groups can also be used. The mentioned chemical reactions do not have to take place completely here. Thus, it is also possible for only some of the free hydroxy groups, i.e. in particular at least one hydroxy group, to be chemically modified.

The modification is preferably carried out before the hydrosilylation reaction. In this case, the modification of the free hydroxy groups can also have a positive influence on the subsequent hydrosilylation reaction.

By way of the fraction of the free hydroxy groups in the polyhydroxyfunctional allyl polyether it is also possible to control the polarity or the compatibility of the polyhydroxyfunctional polysiloxane in the thermoplastic matrix. If many or all of the original hydroxy functions are retained, a high polarity is obtained. By contrast, if many or all of the original hydroxy groups are blocked, the molecule receives a lower polarity.

The polyhydroxyfunctional dendritic allyl compounds based on the ring-opening polymerization of glycidol and polyhydroxyfunctional dendritic allyl compounds based on the ring-opening polymerization of hydroxyoxetanes can in each case be reacted on their own or in combination with the alkyl-hydrogen siloxanes. If the use takes place in the combination, the two allyl compounds can be mixed in any ratio.

In order to be able to adapt compatibilities of the polyhydroxyfunctional polysiloxanes with the thermoplastics, polymeric molding compositions or with the coatings to be applied thereon, it may make sense to use, in combination with the polyhydroxyfunctional allyl compounds used according to the invention, also allyl polyethers which are prepared by the alkoxylation of allyl alcohol or monoallyl ethers having one or more hydroxy groups with alkylene oxides, in particular ethylene oxide and/or propylene oxide and/or butylene oxide and/or styrene oxide. These already long-known allyl polyethers are referred to below, for better clarity, as “unbranched allyl polyethers” and lead to “unbranched polyether radicals” Z—RK in the polysiloxane. In this connection it is possible to prepare both straight alkoxylates and also mixed alkoxylates. In the case of mixed alkoxylates, the alkoxylation may be blockwise, alternating or random. The mixed alkoxylates may also contain a distribution gradient in respect of the alkoxylation.

The end groups or end group of the unbranched allyl polyether may be hydroxyfunctional or else, as has already been described above for the branched polyhydroxyfunctional allyl polyethers according to the invention, may be converted, for example by methylation or acetylation.

The unbranched polyether radical RK is preferably an ethylene oxide ([EO]), a propylene oxide ([PO]) or an ethylene oxide-propylene oxide copolymer of the following formula (III)

RK═—O-[EO]ᵥ-[PO]_{w}-R⁶
where v+w=0-10
where R⁶ is an aliphatic, aromatic, araliphatic compound which can also contain heteroatoms, such as e.g. ester, urethane.

By virtue of different fractions of ([EO]) and ([PO]) it is possible to influence the properties of the polysiloxane according to the invention. Thus it is possible especially on account of the greater hydrophobicity of the [PO] units compared with the [EO] units to control the hydrophobicity of the polysiloxane according to the invention through the selection of suitable [EO]:[PO] ratios.

The copolymers corresponding to the structural formula stated above may be random copolymers, alternating copolymers or block copolymers. It is also possible for a gradient to be formed by the sequence of the alkylene oxide units.

It is possible to use not just one unbranched allyl polyether. For better control of the compatibility it is also possible to use mixtures of different unbranched allyl polyethers.

The reaction can be carried out in such a way that the unbranched allyl polyethers and the branched allyl polyethers are added in succession onto the Si—H-functional allyl polysiloxane. However, the allyl polyethers may also be mixed prior to the addition, meaning that then the allyl polyether mixture is added onto the Si—H-functional alkylpolysiloxane.

In order to be able to adapt compatibilities of the polyhydroxyfunctional polysiloxanes with the thermoplastics or polymeric molding compositions, it may make sense to use, in combination with the polyhydroxyfunctional allyl compounds used according to the invention, also allyl polyesters which can be obtained by esterifying alcohols having an allylic double bond (1-alkenols, such as e.g. 1-hexenol, or hydroxyfunctional allyl polyethers, such as e.g. ethylene glycol monoallyl ether, diethylene glycol monoallyl ether or higher homologs) with hydroxycarboxylic acids, or cyclic esters. Preferably, the esterification takes place via a ring-opening polymerization with propiolactone, caprolactone, valerolactone or dodecalactone, and derivatives thereof. The ring-opening polymerization particularly preferably takes place with caprolactone. In this connection, it is possible to produce either straight polyesters or mixed polyesters. In the case of mixed polyesters, the esterification may be blockwise, alternating or random. The mixed polyesters can also contain a distribution gradient in respect of the esterification.

The end groups of the allyl polyester may be hydroxyfunctional, or else be reacted for example by methylation or acetylation.

The reaction can be carried out such that the allyl polyesters and the branched allyl polyethers are added in succession onto the Si—H-functional alkylpolysiloxane. The branched allyl polyethers and the allyl polyesters may, however, also be mixed before the addition, meaning that then this mixture is added onto the Si—H-functional alkylpolysiloxane.

In order to be able to adapt compatibilities of the polyhydroxyfunctional polysiloxanes with the thermoplastics or polymeric molding compositions, it may make sense to use, in combination with the polyhydroxyfunctional allyl compounds used according to the invention, also mixtures of the aforementioned unbranched allyl polyethers and allyl polyesters.

In general, the compatibilities of the polyhydroxyfunctional polysiloxanes can be adapted to the widest variety of matrices. In order to be able to use the polyhydroxyfunctional polysiloxanes for example in polycarbonates, corresponding polycarbonate modifications can be incorporated into the polyhydroxyfunctional polysiloxanes, as is described e.g. in U.S. Pat. No. 6,072,011.

The Si—H-functional alkylpolysiloxanes used may also be strictly monofunctional, i.e. have only one silane-hydrogen atom. With these it is possible to produce preferred compounds in which exactly one of the groups R² or R³ is a radical R. The monofunctional Si—H-functional alkylpolysiloxanes can be represented for example by the following general formula (V):

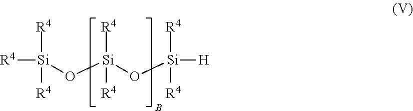

for which the aforementioned definitions for R⁴ and B apply. These compounds produce polyhydroxyfunctional polysiloxanes of the general formula (VI)

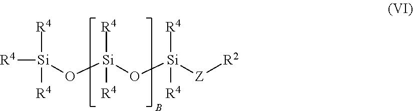

for which the aforementioned definitions for Z, R², R⁴ and B apply. In this case, the group R² is the radical R.

The synthesis of these linear monofunctional polysiloxanes can take place for example via a living anionic polymerization of cyclic polysiloxanes. This method is described inter alia in T. Suzuki in Polymer, 30 (1989) 333. The reaction is depicted by way of example in the following reaction scheme:

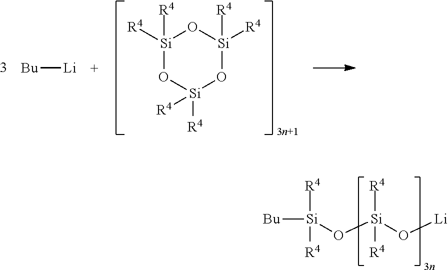

The SiH(R⁴)₂ functionalization of the end group can take place with functional chlorosilanes, for example dialkylchlorosilane, analogously to the following reaction scheme by methods known to the average person skilled in the art.

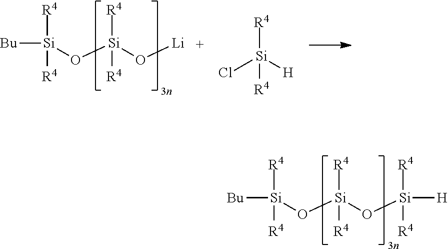

A further possibility for producing linear, monofunctional polysiloxanes is the equilibration of cyclic and open-chain polydiakylsiloxanes with terminally Si—H-difunctional polydialkylsiloxanes, as described in Noll (Chemie and Technologie der Silicone, VCH, Weinhelm, 1984). For statistical reasons the reaction product consists of a mixture of cyclic, difunctional, monofunctional and nonfunctional siloxanes. The fraction of linear siloxanes in the reaction mixture can be increased by distillative removal of the lower cycles. Within the linear polysiloxanes, the fraction of SiH(R⁴)₂-monofunctional polysiloxanes in the reaction product of the equilibrium should be as high as possible. If mixtures of linear polysiloxanes are used, then for the effectiveness of the later products according to the invention, the following applies: the higher the fraction of the monofunctional end products according to the invention, the higher the effectiveness. When mixtures are used, the fraction of the monofunctional end products according to the invention should preferably be the largest fraction in the mixture and preferably be more than 40% by weight. Typical equilibrium products depleted of cyclic impurities contain preferably less than 40% by weight of difunctional and less than 15% by weight of nonfunctional linear polysiloxanes, the latter in particular being present to less than 5% by weight, and ideally not at all.

One example of a chain-like polyhydroxyfunctional polysiloxane according to the invention is shown in the following formula (VII):

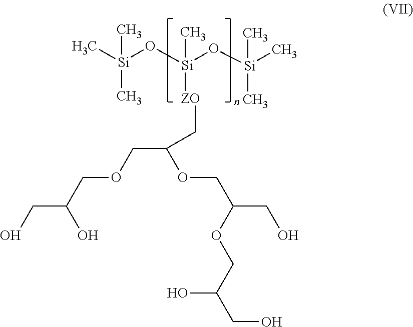

A reaction example of a monofunctional silicone with a branched polyether radical is shown in the following formula (VIII):

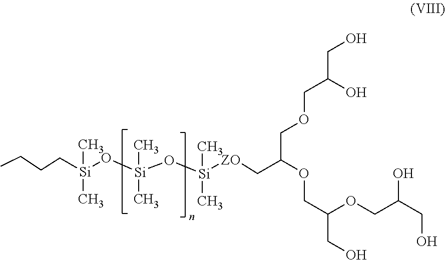

The hydrosilylation, i.e. the reaction of the Si—H-functional alkylpolysiloxanes with the polyhydroxyfunctional dendritic allyl compounds, takes place in the presence of an acid-buffering agent. Acid-buffering agents which may be used are, for example, sodium acetate or potassium acetate in amounts of from 25 to 200 ppm. Typically, the hydrosilylation takes place under the following conditions: the Si—H-functional alkylpolysiloxane is introduced as an initial charge at room temperature. Then, for example, 25 to 100 ppm of a potassium acetate solution are added, in order to suppress any secondary reactions. Depending on the exothermie of the reaction that is to be expected, some or all of the allyl compounds are added. Under a nitrogen atmosphere, the contents of the reactor are then heated to 75° C. to 80° C. A catalyst, such as a transition metal, for example nickel, nickel salts, iridium salts or preferably a noble metal from group VIII, such as, for example, hexachloroplatinic aid or cis-diammineplatinum(II) dichloride, is then added. The temperature increases as a result of the exothermic reaction which then takes place. Normally, an attempt is made to keep the temperature within a range from 90° C. to 120° C. If some of the allyl compounds still have to be metered in, the addition takes place such that the temperature of 90° C. to 120° C. is not exceeded, but also such that the temperature does not drop below 70° C. Following complete addition, the temperature is held at 90° C. to 120° C. for a certain time. The course of the reaction can be monitored by infrared spectroscopy for the disappearance of the absorption band of the silicon hydride (Si—H: 2150 cm⁻¹).

The polyhydroxyfunctional polysiloxanes according to the invention can also be chemically modified subsequently in order, for example, to establish certain compatibilities with binders. The modifications may be carried out for example by means of acetylation, methylation, or reaction with monoisocyanates (e.g. TDI-monoadducts, which can be synthesized by the reaction of polyether monools with TDI (toluenediisocyanate)). Moreover, by means of reaction with carboxylic anhydrides, for example with phthalic anhydride or succinic anhydride, it is possible to incorporate acid functions. Here, the hydroxy groups may be partially or completely reacted. Through reaction with corresponding unsaturated anhydrides, for example maleic anhydride, it is possible to incorporate not only a carboxyl group but also one or more reactive double bonds into the molecule. In this connection, the hydroxy functions can also be reacted with structurally different anhydrides. In order to achieve better solubility in water, the carboxy groups can also be salified with alkanolamines. Furthermore, through subsequent acrylation or methacrylation on the hydroxy groups, it is possible to obtain products which can be incorporated firmly into paint systems even in radiation-curing operations, such as UV curing and electron-beam curing. The hydroxy groups can also be esterified by ring-opening polymerization with propiolactone, caprolactone, valerolactone or dodecalactone, and also derivatives thereof. The ring-opening polymerization takes place particularly preferably with caprolactone. In this connection, it is possible to produce either straight polyesters or mixed polyesters. In mixed polyesters, the esterification can be blockwise, alternating or random. It is also possible for the mixed polyesters to contain a distribution gradient in respect of the esterification.

Besides the described polysiloxanes according to the invention and the use according to the invention of these polysiloxanes, the present invention also provides the methods stated above and in the claims for producing the polysiloxanes according to the invention.

The present invention further provides a method for increasing the surface energy of thermoplastics and polymeric molding compositions, and to the resulting thermoplastics and polymeric molding compositions themselves.

In the method according to the invention for increasing the surface energy of thermoplastics and polymeric molding compositions, 0.1-10% by weight, preferably from 0.1 to 7.5% by weight, very particularly preferably from 0.1 to 5% by weight, based on the resulting thermoplastics and/or the resulting molding composition, of at least one polysiloxane according to the invention are added to the thermoplastic or the polymeric molding composition before the polymerization. This use according to the invention of the polysiloxanes according to the invention as additive in thermoplastics or polymeric molding compositions gives the thermoplastics and polymeric molding compositions according to the invention.

The thermoplastics, or else thermoplastic blends or polymeric molding compositions according to the invention comprise the polyhydroxyfunctional polysiloxanes as active substance (100% strength form) in amounts of from 0.1 to 10% by weight, preferably from 0.1 to 7.5% by weight, very particularly preferably from 0.1 to 5% by weight, based on the thermoplastics or the polymeric molding composition or polymer mixture.

The thermoplastics produced with the polyhydroxyfunctional polysiloxanes according to the invention can be used in pigmented or unpigmented form; moreover, the thermoplastics, or else thermoplastic blends and polymeric molding compositions can comprise standard commercial fillers, such as e.g. calcium carbonate, aluminum hydroxide, talc, Wollasitonite and/or strengthening fibers such as glass fibers, carbon fibers and aramid fibers. Furthermore, the thermoplastics or else thermoplastic blends and polymeric molding compositions produced with the polyhydroxyfunctional polysiloxanes according to the invention can comprise other standard commercial additives and/or additional substances, such as, for example, wetting agents and dispersants, photostabilizers and anti-aging agents, acid scavengers and also nucleating agents, and the like, as well as processing auxiliaries, such as e.g. lubricants or release agents and also so-called processing aids. The types and amounts of these additives or additional substances used in each case are governed by the particular requirement placed on the end product to be produced, and by the knowledge of the person working in the respective area of requirement. Usually, one or more of these additives, individually and/or combined together, are used, depending on type, up to 8% by weight (based on the total mixture).

As additives such as
standard commercial fillers (as specified above by way of example)
pigments or dyes
plasticizers,
   usually one or more additives, individually and/or combined, are used up to 90% by weight (based on the total mixture).

Additives or additional substances of this type are generally commercially available and described and listed e.g. in Gächter/Müller, Plastics additives Handbook, 4th edition, Hansa Verlag; Munich, 1993.

The polymeric molding compositions produced with the polyhydroxyfunctional polysiloxanes according to the invention are preferably polymeric molding compositions of unsaturated polyester resins, epoxide resins, vinyl ester resins, polyester resins, polyurethane resins and/or alkyd resins. The polymeric molding compositions may likewise be pigmented in any desired combination and/or be filled with the aforementioned fillers and/or additives.

The blends produced with the polyhydroxyfunctional polysiloxanes according to the invention are particularly preferably mixtures of homo- and/or copolymeric thermoplastics. Thermoplastics for the purposes of the invention include e.g. polyethylene, polypropylene, polyoxymethylene, ethylene vinyl acetates (EVA), poly(meth)acrylates, polyacrylonitrile, polystyrene, styrenic polymers (e.g. ABS, SEBS, SBS), polyesters, polyvinyl esters, polycarbonates (PC), polyethylene terephthalate (PET), polybutylene terephthalate (PBT), polyamides (PA), polybutadienes (PB), thermoplastic polyurethanes (TPU), thermoplastic elastomers (TPE), polyvinyl chloride (with and without plasticizer), and also polylactic acid (PLA). The thermoplastics can be filled and/or pigmented. Within the context of the invention, the term “thermoplastics” also includes mixtures (blends) of different types of thermoplastics. The thermoplastics may for example also be spinnable thermoplastic fibers known to the average person skilled in the art, such as, for example, PP, polyester or polyamide fibers.

The polysiloxanes according to the invention are particularly well suited to increasing the surface energy of thermoplastics and polymeric molding compositions. Thermoplastics and polymeric molding compositions are obtained which have typical properties which result from the increase in the surface energy, such as e.g. a reduced contact angle with water, improved antistatic properties and an improved adhesion of coatings such as paints or printing inks.

The surface energy of the thermoplastics and polymeric molding compositions can be determined for example by measuring the static contact angle of the surface with water. The smaller the static contact angle of the surface with water, the greater the surface energy of the surface. The static contact angle can be measured using standard commercial contact angle measuring devices known to the person skilled in the art, for example using a contact angle measuring device from Krüss (model Easy prop, equipped with a camera).

The thermoplastics and polymeric molding compositions according to the invention have a higher surface energy than thermoplastics and polymeric molding compositions which do not comprise the polysiloxanes according to the invention.

The printability of the thermoplastics and polymeric molding compositions can be characterized for example by applying a printing ink to the thermoplastic or the polymeric molding composition and then testing the adhesion of the printing ink on the surface of the thermoplastic or polymeric molding mass. This can be done for example by pressing on and pulling off an adhesive film (such as e.g. Tesafilm) on the printed surface before and/or after the printing ink has dried.

Within the context of this invention, printing inks are understood as meaning colorant-containing preparations of varying consistency. In contrast to coating compositions, printing inks are not intended to constitute protection for the imprinted substrate, but, in a typical printing process, color parts of the substrate and leave other parts of the substrate uncolored. The color layers formed in a typical printing operation are much thinner than in the case of compositions that are painted on. Besides colorants, a typical printing ink can also comprise fillers, binders, solvents, diluents and/or further auxiliaries.

The thermoplastics and polymeric molding compositions according to the invention have better printability than thermoplastics and polymeric molding compositions which do not comprise the polysiloxanes according to the invention.

The polysiloxanes and thermoplastics and polymeric molding compositions according to the invention can be used as additive, or else as masterbatch (concentrate) or else as direct compound.

The polysiloxanes and thermoplastics or polymeric molding compositions according to the invention are generally used in intermediate products (semi-finished products) and finished goods (end products) in the thermoplastics industry. The intermediate products and end products can be produced for example by means of extrusion processes, injection molding or else special processes such as rotational centrifugal molding or compounding. They may for example be films of very different types. The thermoplastics or polymeric molding compositions according to the invention can thus for example be in the form of extrudates, fibers, film or moldings. Additional, subsequent processing steps such as e.g. fiber spinning processes, deep-drawing processes and/or other further processing processes known in the manufacturing industry can yet further increase the effect of the products according to the invention.

The examples below illustrate the invention without having a limiting effect:

### EXAMPLES

### I). Preparation of the Allyl Polyethers 1-7

### Synthesis of an Allyl-Functional Polyglycidol (Allyl Polyether 1)

22.71 g of potassium tert-butanolate, 100 ml of THF and 120 mg of BHT were charged to a 1000 ml 4-neck flask fitted with stirrer, thermometer, distillation bridge and dropping funnel, and stirred at ca. 20° C. under N2-atmosphere (gentle N2 stream during the entire reaction). 344.63 g of ethylene glycol monoallyl ether were then slowly added, during which the temperature increased to 35° C. The resulting brown-orange solution was heated at 40° C. for 15 min. The temperature was then increased to 90° C. and, over the course of one hour, THF and tert-butanol were distilled off. 500 g of glycidol were slowly added dropwise over 6 hours. When the metered addition of glycidol was complete, stirring was carried out for a further hour at 110° C. Monitoring via NMR revealed a complete conversion. After cooling to room temperature, 200 ml of methanol were added and the product was neutralized with 400 ml of Amberlite 1R120 H. After filtering off the ion exchanger, methanol was removed in vacuo.

### Synthesis of Further Allyl-Functional Polyglycidols (Allyl Polyethers 2 to 5)

The allyl polyethers 2-5 were prepared analogously to polyether 1, except that a different initiator or different glycidol ratios were chosen.

Synthesis of an Allyl-Functional Polyqlycidol with Subsequent Ethoxylation (Allyl Polyether 8)

Allyl polyether 8 was prepared analogously to allyl polyether 1, a different glycidol ratio (4 mol of glycidol per 1 mol of allyl starter compound) being chosen, with subsequent alkoxylation with ethylene oxide. The subsequent ethoxylation was carried out by processes that are sufficiently well known.

### Synthesis of an Allyl-Functional Allyl Polyether Based on a Trimethylolpropane Oxetane Ethoxylate (Allyl Polyether 6)

46.9 g of ethylene glycol monoallyl ether were introduced as initial charge under N2 atmosphere in a 250 ml 4-neck flask fitted with stirrer, thermometer, reflux condenser and dropping funnel, and heated to 110° C. (a gentle N2 stream was maintained during the entire reaction). Upon reaching a temperature of ca. 50° C., 0.5 g of BF3 etherate was added. At 110° C., the metered addition of 120 g of ethoxylated trimethylolpropane oxetane (TOP33) was started. The metered addition was completed in 40 minutes. The mixture was then held at 110° C. for 6 h. A light yellow viscous liquid was obtained.

Synthesis of an Allyl-Functional Allyl Polyether by Reacting an Allyl Polyether Based on 1 Mol of Trimethylolpropane Monoallyl Ether and 2 Mol of Trimethylolpropane Oxetane by Reaction with a TDI-MPEG350 Monoadduct (Allyl Polyether 7)

31.1 g of an allyl polyether with theoretically 4 OH groups, which is obtained from the reaction of trimethylolpropane monoallyl ether with trimethylolpropane oxetane in the molar ratio 1:2, (iodine number=63.3 g I₂/100 g) and 81.9 g of a monoadduct of TDI and MPEG350 (7.7% isocyanate) are introduced as initial charge at room temperature in a 250 ml 4-neck flask fitted with stirrer, thermometer, reflux condenser and dropping funnel. During the entire reaction, nitrogen is passed over. The mixture is heated to 60° C. and held under these conditions for ca. 4 hours. During the subsequent analysis of the reaction mixture, isocyanate could no longer be detected. A light yellow viscous liquid was obtained.

### II.) Reaction of Methyl-Hydrogen Siloxanes with Various Allyl Polyethers

### Example 5

### Reaction of a Methyl-Hydrogen Siloxane with the Average Formula MD^{H}₁M and Allyl Polyether 6

At room temperature, 18.90 g of a methyl-hydrogen siloxane with the average formula MD^{H}₁M, 41.10 g of allyl polyether 6, 0.03 g of BHT, 0.06 g of a 10% strength ethanolic potassium acetate solution were introduced as initial charge in a 250 ml 3-neck flask fitted with stirrer, thermometer and reflux condenser. Under a nitrogen atmosphere, the mixture was heated to ca. 80° C. Upon reaching this temperature, ca. 0.18 g of a 0.6% strength isopropanolic solution of Speier's catalyst was added. As a result of the exothermic reaction, the temperature increases and, after the first exotherm has subsided, is adjusted to 105° C. After ca. 6 hours under these conditions, Si—H groups could no longer be detected by gas volumetric analysis. In the subsequent distillation, under a vacuum of about 20 mbar at 130° C., all volatile constituents were distilled off in one hour. A pale brown, slightly cloudy, viscous product is obtained.

### Example 6

### Reaction of a Methyl-Hydrogen Siloxane with the Average Formula MD^{H}₁D₁M and Allyl Polyether 1

At room temperature, 59.95 g of a methyl-hydrogen siloxane with the average formula MD^{H}₁D₁M and 70.05 g of allyl polyether 1 are introduced as initial charge in a 250 ml 3-neck flask fitted with stirrer, thermometer, reflux condenser, and are heated with 0.26 g of potassium acetate solution (10% strength by weight in ethanol) to 80° C. under a nitrogen atmosphere. Upon reaching this temperature, 0.039 g of Speier's catalyst (6% strength by weight solution in isopropanol) is added. The temperature is increased to 100° C. and the mixture is held under these conditions for 120 minutes. A gas-volumetric determination of the remaining Si—H groups reveals a degree of conversion of 100%.

### Example 16

### Reaction of a Methyl-Hydrogen Siloxane with the Average Formula MD^{H}₁D₅M and Allyl Polyether 7

At room temperature, 17.79 g of a methyl-hydrogen siloxane with the average formula MD^{H}_{1.5}D₅M, iodine number Si—H=63.2 mg KOH/g, 86.2 g allyl polyether 7, 0.03 g BHT and 0.05 g of a 10% strength ethanolic potassium acetate solution were introduced as initial charge in a 250 ml 3-neck flask fitted with stirrer, thermometer, reflux condenser. The mixture was heated to ca. 80° C. under nitrogen atmosphere. Upon reaching this temperature, ca. 0.52 g of a 0.6% strength isopropanolic solution of Speier's catalyst was added. As a result of the exothermic reaction, the temperature increases and, after the first exotherm has subsided, is adjusted to 110° C. After ca. 5 hours under these conditions, Si—H groups could no longer be detected by gas volumetric analysis. In the subsequent distillation, under a vacuum of about 20 mbar at 130° C., all volatile constituents are distilled off in one hour. A pale brown, slightly cloudy, viscous product is obtained.

### Example 17

### Reaction of a Methyl-Hydrogen Siloxane with the Average Formula MD^{H}₂D₁M and Alpha-Olefin C8 and Allyl Polyether 2

At room temperature, 51.8 g of a methyl-hydrogen siloxane with the average formula MD^{H}₂D₁M, 21.11 g of alpha-olefin C8 and 77.1 g of allyl polyether 2 and also 0.3 g of potassium acetate solution (10% by weight in ethanol) and 50.0 g of Dowanol PM are introduced as initial charge in a 250 ml 3-neck flask fitted with stirrer, thermometer, reflux condenser, and heated to 80° C. under nitrogen atmosphere. Upon reaching this temperature, 0.52 g of Speier's catalyst (6% strength by weight solution in isopropanol) is added. The temperature is increased to 100° C. and the mixture is held under these conditions for 120 minutes. A gas-volumetric determination of the remaining Si—H groups reveals a complete conversion.

### Example 18

### Reaction of a Methyl-Hydrogen Siloxane with the Average Formula MD^{H}₂D₁M and Allyl Polyether RK₁ and Allyl Polyether 4

At room temperature, 47.4 g of a methyl-hydrogen siloxane with the average formula MD^{H}₂D₁M, 37.9 g of allyl polyether RK₁ and 64.6 g of allyl polyether 4 and 0.3 g of potassium acetate solution (10% by weight in ethanol) and 37.5 g of Dowanol PM are introduced as initial charge in a 250 ml 3-neck flask fitted with stirrer, thermometer and reflux condenser, and heated to 80° C. under nitrogen atmosphere. Upon reaching this temperature, 0.52 g of Speier's catalyst (6% strength by weight solution in isopropanol) is added. The temperature is then increased to 100° C. and held for 4 hours. Gas-volumetric determination of the remaining Si—H groups reveals a complete conversion.

### Example 20

At room temperature, 87.2 g of a methyl-hydrogen siloxane with the average formula MD^{H}₁D₁D₁M, 212.8 g of allyl polyether 8, 100.0 g of methoxypropanol and 0.45 g of potassium acetate solution (10% strength by weight in ethanol) are introduced as initial charge in a 500 ml 3-neck flask fitted with stirrer, thermometer and reflux condenser, and heated to 80° C. under nitrogen atmosphere. Upon reaching this temperature, 0.1 g of Speier's catalyst (6% strength by weight solution in isopropanol) is added. The temperature is increased to 100° C. and the mixture is held under these conditions for 120 minutes. A gas-volumetric determination of the remaining Si—H group reveals a degree of conversion of 100%.

### Further Examples

The other products of the present invention were prepared analogously as described in the examples given above. The structures of all of the substances are described in the table below, but are not limited by these.

Table with average structures for all examples

| | | Number of | R |
|---|---|---|---|
| Example | Siloxane | OH groups | RK |
| Example 1 | MD^{H}₁M | 3.5 | Allyl polyether 1 |
| Example 2 | MD^{H}₁M | 5.2 | Allyl polyether 2 |
| Example 3 | MD^{H}₁M | 6.4 | Allyl polyether 3 |
| Example 4 | MD^{H}₁M | 5 | Allyl polyether 4 |
| Example 5 | MD^{H}₁M | 2 | Allyl polyether 6 |
| Example 6 | MD^{H}₁D₁M | 3.5 | Allyl polyether 1 |
| Example 7 | MD^{H}₁D₁M | 6.4 | Allyl polyether 3 |
| Example 8 | MD^{H}₁D₁M | 5 | Allyl polyether 4 |
| Example 20 | MD^{H}₁D₁M | 5 | Allyl polyether 8 |
| Example 9 | MD^{H}₂DM | 3.5 | Allyl polyether 1 |
| Example 10 | MD^{H}₂DM | 5.2 | Allyl polyether 2 |
| Example 11 | MD^{H}₂DM | 6.4 | Allyl polyether 3 |
| Example 12 | MD^{H}₂DM | 5 | Allyl polyether 4 |
| Example 13 | MD^{H}₂DM | 7 | Allyl polyether 5 |
| Example 14 | MD^{H}₂D₂M | 3.5 | Allyl polyether 1 |
| Example 15 | MD^{H}₄D₂M | 5.2 | Allyl polyether 2 |
| Example 16 | MD^{H}_{1.5}D₅M | 4 | Allyl polyether 7 |
| Example 17 | MD^{H}₂D₁M | 5.2 | Allyl polyether 2 |
| | | | Alpha-olefin C8 |
| Example 18 | MD^{H}₂D₁M | 6 | Allyl polyether 4 |
| | | | Allyl polyether RK₁ |
| Example 19 | MD^{H}₂D₁M | 4.5 | Allyl polyether 1 |
| | | | Allyl polyether RK₂ |

### Legend:

For the methyl-hydrogen siloxanes given above, the meanings of the listed abbreviations are defined as follows:

### M=—O_{0.5}Si (CH₃)₃

### M^{H}=—O_{0.5}SiH(CH₃)₂

### D=—O_{0.5}Si(CH₃)₂O_{0.5}—

### D^{H}=—O_{0.5}SiH(CH₃)O_{0.5}—

### Abbreviations Also Used:

Allyl polyether 1=
Ethylene glycol monoallyl ether with on average 2.5 mol of glycidol
OH number=687 mg KOH/g
Iodine number=86.8 g I₂/100 g
Allyl polyether 2=
Ethylene glycol monoallyl ether with on average 4.2 mol of glycidol
OH number=713 mg KOH/g
Iodine number=61.7 g I₂/100 g
Allyl polyether 3=
Ethylene glycol monoallyl ether with on average 5.4 mol of glycidol
OH number=727 mg KOH/g
Iodine number=51.5 g I₂/100 g
Allyl polyether 4=
Allyl alcohol with on average 4 mol of glycidol
OH number=777.1 mg KOH/g
Iodine number=68.3 g I₂/100 g
Allyl polyether 5=
Allyl alcohol with an average 6 mol of glycidol
OH number=767 mg KOH/g
Iodine number=48.3 g I₂/100 g
Allyl polyether 6=
Ethylene glycol monoallyl ether with ethoxylated trimethylolpropane oxetane with on average 3.3 mol of EO
OH number=308 mg KOH/g
Iodine number=61.9 g I₂/100 g
Allyl polyether 7=
Trimethylolpropane monoallyl ether with 2 mol of trimethylolpropane oxetane and subsequent addition of MPEG350 monoTDI adduct.
OH number=158.4 mg KOH/g
Iodine number=35.3 g I₂/100 g
Allyl polyether 8=
Allyl alcohol with on average 4 mol of glycidol ethoxylated with 5 mol of EO (1 mol of EO per OH group)
OH number=522 mg KOH/g
Iodine number=45 g I₂/100 g
Allyl polyether RK₁=
Unbranched allyl polyether, allyl alcohol-started ethylene oxide polyether
Molecular weight ca. 225 g/mol
OH number=250 mg/KOH/g
Iodine number=113 g I₂/100 g
Allyl polyether RK₂=
Unbranched allyl polyether, allyl alcohol-started propylene oxide polyether
Molecular weight ca. 240 g/mol
OH number=235 mg KOH/g
Iodine number=106.0 g I₂/100 g
Alpha-olefin C8=1-octene, molecular weight 112.21 g/mol
Iodine number=226 g I₂/100 g
Speier's catalyst=H₂[PtCl₆], 6 H₂O
Dowanol PM=1-methoxy-2-propanol
TOP33=ethoxylated trimethylol oxetane, Perstrop Specialty Chemicals, SE-Perstorp
BHT=2,6-di-tert-butyl-p-cresol
DBTL=dibutyltin dilaurate
MPEG350=methanol-started polyethylene glycol with an average molecular weight of 350 (Ineos Oxide)
TDI=toluene diisocyanate

### III.) Incorporation of the Additives and Determination of the Contact Angle with Water

For evaluating the products, at the start polymer blends were produced on the laboratory roll mill (Polymix 110 L, Servitec) with a roll diameter of 110 mm at a friction of 1.2; the friction arises from the different rotational speeds of the rolls (front 20 rpm/rear 24 rpm). The processing temperature was adapted to the particular thermoplastic to be tested (140° to 190° C.), as was the gap adjustment of 0.7-0.9 mm. To produce the polymer blends, firstly in each case 100 g of the thermoplastic polymer to be tested was melted during the first 2 minutes, then the additive was added and then turned for a further mixing time of 4-6 min (according to thermoplastic). Overall, this results in a total mixing time, depending on the polymer, of 4-10 min.

Test films are then pressed from the blends on a laboratory press (Polystat 200 T, Servitec) at 190° C. and 300 bar during a residence time of 30 seconds (layer thickness 300-300 μm). These films are conditioned overnight at RT and then the contact angle is determined using completely demineralized water.

To assess the wettability, the contact angles of the additive-containing substrates (thermoplastics and molding compositions) were determined by means of contact angle measurements using completely demineralized water.

The higher the polar fractions in the substrate, the better the wetting behavior; i.e. the lower the contact angle with water, the more effective the additive used in the substrate.

A reduction in the contact angle with water on the surface indicates an increase in the surface tension of the substrate to be tested.

The static contact angle with water on the surface of the additive-containing substrate was therefore used in order to characterize the hydrophilicity of the surface.

The measurements were carried out under conditioned conditions (23° C.; 65% relative atmospheric humidity) using a contact angle measuring device from Krüss (model Easy Drop, fitted with a camera). The contact angles are evaluated using associated analysis software. In principle, measurements were carried out in triplicate. The stated characteristic values are averages, any deviations are shown as +/−.

The results below are examples of the applications-related effect of the additives, without limitation to the scope of use in the various thermoplastic polymers or polymeric blends, or polymeric molding compositions.

The described additives were tested in the various concentrations (data in % by weight of total mixture), as described in the tables below.

The contact angle with water was always determined in each case after conditioning for 24 hours.

The homogeneity of the substrates (films) was determined through investigations of the topside and bottom side of the film. All of the data are averages from top and bottom; deviations are ascertained as +/−.

Data relating to the thermoplastics used:
LDPE—Low density polyethylene; MFI at 230° C./2.16 kg 0.27 g/10 min.
   (Riblene FC 40, Polimeri—Europe; characterization: high molecular LDPE)
HDPE—High density polyethylene; MFI at 230° C./2.16 kg 7 g/10 min (Eraclene MP 90, Polimeri—Europe; characterization: HDPE with small MW distribution—additivated with antioxidants)
PPC—Polypropylene copolymer; MFI at 230° C./2.16 kg 7 g/10 min (PPC 5660, Total—Petrochemicals; characterization—heterophasic copolymer)
PPH—Polypropylene homopolymer; MFI at 230° C./2.16 kg 25 g/min (PPH 9069, Total—Petrochemicals; characterization—grade for nonwovens fabrics)
PVC-rigid—Polyvinyl chloride (Solvic 257 RF, Solvay; characterization: suspension grade, K value=57)
ABS—Acrylonitrile butadiene styrene: MVR at 220° C./10 kg 26 cm³/10 min (Magnum 8391, DOW Chemicals; characterization—custom grade with medium impact resistance)

### Example with LDPE (Table 1)

TABLE 1
LDPE

| | |
|---|---|
| Additive | Water contact angle |
| conc. in | [°] |

| Additive | polymer | Average | Deviation |
|---|---|---|---|
| Example | [%] | top/bottom | top/bottom |
| Control | Without | 87.3 | 2.7 |
| | additive | | |
| Example 5 | 0.2 | 46.0 | 6.0 |
| Example 6 | 0.2 | 4.2 | 0.5 |
| Example 20 | 0.2 | 3.6 | 1.1 |
| Example 13 | 0.2 | 2.9 | 1.1 |
| Example 14 | 0.2 | 3 | 1 |
| Example 17 | 0.2 | 7 | 1 |
| Example 18 | 0.2 | 3 | 1 |

The results reveal that the admixing of even small amounts of the substances (additive) according to the invention in LPDE leads to a drastic reduction in the contact angle with water compared to the control (polymer without additive) (table 1).

### Example with PPH (table 2)

TABLE 2
PPH

| | |
|---|---|
| Additive | Water contact angle |
| conc. in | [°] |

| Additive | polymer | Average | Deviation |
|---|---|---|---|
| Example | [%] | top/bottom | top/bottom |
| Control | Without | 100.8 | 1.9 |
| | additive | | |
| Competitor | 2 | 99.4° | 1.4° |
| sample | | | |
| IRGASURF ® | | | |
| HL 560* | | | |
| Example 1 | 2 | 7.0° | 2.5° |
| Example 3 | 2 | 11.7° | 0.2° |
| Example 7 | 2 | 10.1° | 1.2° |
| Example 10 | 2 | 5.5° | 1.2° |
| Example 12 | 2 | 4.0° | 0.5° |

*IRGASURF ® HL 560, Ciba Specialty Chemicals

The results reveal that the admixing of even small amounts of the substances (additive) according to the invention in PPH leads to a drastic reduction in the contact angle with water compared with the control (polymer without additive) (table 2). The addition of the commercially available additive “Irgasurf HL 560” does not exhibit the same efficiency by a long way in reducing the contact angle with water.

### Example with PVC (table 3)

TABLE 3
PVC*

| | |
|---|---|
| Additive | Water contact angle |
| conc. in | [°] |

| Additive | polymer | Average | Deviation |
|---|---|---|---|
| Example | [%] | top/bottom | top/bottom |
| Standard | Without | 77.7 | 1.7 |
| | additive | | |
| Standard + | 1.0 | 2.4 | 0.4 |
| Example 2 | | | |
| Standard + | 1.0 | 4.3 | 0.5 |
| Example 4 | | | |
| Standard + | 1.0 | 4.0 | 1.3 |
| Example 9 | | | |
| Standard + | 1.0 | 2.5 | 0.2 |
| Example 11 | | | |
| Standard + | 1.0 | 11.1 | 6.8 |
| Example 15 | | | |

*PVC (standard: 100 parts of PVC/2.0 parts of BaZn stabilizer/0.2 parts of BYK ®-P 4100)

The results reveal that the admixing of even small amounts of the substances (additive) according to the invention in PVC leads to a drastic reduction in the contact angle with water compared to the standard (stabilized PVC with process additive—without addition of further additive) (table 3).

### Additional Examples

Table 4 gives a number of examples of the optimum dosing of the substance according to the invention (example 8). The minimum use amount in various polymers which is required in order to achieve complete wetting (contact angle<10°) is given.

TABLE 4
Overview of the use amounts (example 8) in various polymers

| | | | | % by | | |
|---|---|---|---|---|---|---|
| | | | | weight of | | |
| Ther- | | | % by | additives | | Devia- |
| mo- | | | weight of | (30% on | Average | tion |
| plastic | | | additives | carrier*) | top/ | top/ |
| polymer | Control | Additive | in polymer | in polymer | bottom | bottom |
| LDPE | Control | | | | 92 | ±4 |
| LDPE | | Example 8 | | 0.5 | 4 | ±1 |
| HDPE | Control | | | | 90 | ±3 |
| HDPE | | Example 8 | 1.00 | | 5 | ±3 |
| PPC | Control | | | | 89 | ±0 |
| PPC | | Example 8 | 1.25 | | 5 | ±0 |
| PPH | Control | | | | 103 | ±1 |
| PPH | | Example 8 | 1.50 | | 5 | ±2 |
| PVC | Control | | | | 67 | ±1 |
| rigid | | | | | | |
| PVC | | Example 8 | 0.50 | | 3 | ±1 |
| rigid | | | | | | |
| ABS | Control | | | | 71 | ±2 |
| ABS | | Example 8 | 2.00 | | 5 | ±1 |

*Carrier: Accurel ® XP 100; Membrana GmbH Accurel Systems

Through the additivation it is thus possible to adjust the wetting behavior of the substrate to aqueous paint dispersions or aqueous printing inks. Since commercially highly diverse paint formulations and printing ink formulations are used, for the purposes of a clear comparison water has been used here for the determination of the contact angle.

### IV.) Adhesion Test

### Procedure:

Using the cutting side of an etching knife (artists' utensil)—held at a right angle to the sample substrate—the coating is scratched away under pressure by pulling (sideways movement, not cutting) the knife down to the substrate or, in the case of multilayer systems, to the layer which is to be assessed. Here, the coating must be scratched away in a width of several millimeters. In the case of hard coatings, it is occasionally necessary to press with both hands on the knife. The knife must not have a cutting action (achieved by holding it at a slant).

### Evaluation

The evaluation was carried out according to the assessment in accordance with DIN 53230 using the following grades:
0=The coating adheres very well and exhibits completely smooth edges at the scratched-off points.
1=The coating adheres very well, but exhibits jagged edges.
2=The coating adheres well, can be scratched off using the entire supporting surface of the knife; smooth edges.
3=The coating adheres well, can be scratched off using the entire supporting surface of the knife; jagged edges.
4=Worse than 3; peeling
5=Inadequate adhesion; peeling off of the coating

The paint adhesion was tested using Alberdingk AS 26080 VP, a system from Alberdingk Boley GmbH; field of application: Hifi-TV, plastic substrates.

This paint primer is a polymer dispersion (copolymer of acrylic acid esters and styrene).

A coating thickness of 120 μm was applied. The films coated in this way were then dried in an oven for 30 min at 80° C.

The wetting behavior (silicone disturbances) was assessed directly after coating. The adhesion test was carried out on the following day.

| | | Surface | |
|---|---|---|---|
| | | assessment | |
| Additive | | wetting | |
| example 8 in | Contact | behavior | |
| PPC | angle | (silicone | Adhesion/ |
| [conc. in %] | water | disturbances) | paint |
| 0 - sample | 89° | 1) OK | 1) 5 |
| | | 2) OK | 2) 5 |
| 0.50% | 80° | 1) OK | 1) 5 |
| | | 2) OK | 2) 4-5 |
| 1.00% | 47° | 1) OK | 1) 4 |
| | | 2) OK | 2) 4 |
| 1.75% | 5° | 1) OK | 1) 3 |
| | | 2) OK | 2) 3 |

Samples 1 and 2)=double determinations

The adhesion of a printing ink was tested using the following printing ink formulation:
65% Joncryl 8052; acrylate resin, BASF
35% Flexiverse Blue; aqueous pigment paste; SUN-Chemicals, based on Joncral 8078; styrene-acrylate—ammonium salted

The printing ink was applied in a layer thickness of 12 μm using a spiral-wound doctor blade and then briefly dried under a hairdryer.

The wetting behavior (silicone disturbances) was assessed directly after application. The adhesion was tested with a Tesafilm immediately and after 24 h.

| | | Surface | |
|---|---|---|---|
| | | assessment | |
| Additive | | wetting | |
| example 8 in | | behavior | |
| PPC | Contact angle | (silicone | Adhesion/ |
| [conc. in %] | water | disturbances) | printing ink |
| 0 - sample | 103° | 1) OK | 1) 4 |
| | | 2) OK | 2) 4-5 |
| 0.50% | 71° | 1) OK | 1) 3 |
| | | 2) OK | 2) 3-4 |
| 0.75% | 62° | 1) OK | 1) 3 |
| | | 2) OK | 2) 3 |
| 1.00% | 59° | 1) OK | 1) 3 |
| | | 2) OK | 2) 3 |
| 1.25% | 30° | 1) OK | 1) 2 |
| | | 2) OK | 2) 2-3 |

Samples 1 and 2)=double determinations

Both in the case of the aqueous polymer dispersion on PPC, and also in the case of the printing ink on PPH, it can be observed that the adhesion can be improved through additization with the substances according to the invention.

Fundamental properties of the polymers, such as, e.g. transparency, thermostability, rheological flow behavior, are not adversely affected by the addition of the additives in the use amounts as directed.

### V.) Antistatic Properties

A mixture of 100 g of polymer and additive in the stated dosage series were mixed on a roll mill and compressed to give films (description, as above). The films were homogeneous and easy to produce. The films were conditioned under constant conditions (23° C./65% relative atmospheric humidity) and then measured using a measuring device “Tera-Ohm-Meter 6206”, from Eltex by means of ring electrode. Measurement voltage: 100 V. Example 8 in PPC was investigated.

The surface resistance after conditioning for one day was assessed. The surface resistance is the term used to refer to the “electrical resistance” which a material opposes a current which flows on the material surface.

| | Additive | | Surface resistance | |
|---|---|---|---|---|
| | concentration | Contact | [ohm] | |
| Sample | in polymer | angle | Sample | Sample |
| Name | (PPC) [%] | water | top | bottom |
| Control | 0.00 | 89° | 1.6 × 10E13 | 8.7 × 10E12 |
| Example 8 | 0.50 | 80° | 8.0 × 10E10 | 9.5 × 10E10 |
| Example 8 | 1.00 | 47° | 2.7 × 10E10 | 4.3 × 10E10 |

It is evident from the examples in the table that the substance according to the invention brings about a reduction in the surface resistance and thus displays a good antistatic effect.

1. The use of a polyether-modified polyhydroxyfunctional polysiloxane preparable by
i) firstly reacting at least one (meth)allylic starter compound having at least one hydrogen-active group with at least one reagent selected from the group consisting of glycidol, glycerol carbonate and hydroxyoxetanes such that, with ring opening, at least one (meth)allyl polyether is formed which comprises at least one branched polyglycidol radical and/or at least one branched polyoxetane radical, and then
ii) adding the (meth)allyl polyether(s) obtained in the presence of an acid-buffering agent onto an Si—H-functional alkylpolysiloxane,
as additive in thermoplastics or polymeric molding compositions for improving the printability.

2. The use as claimed in claim 1, characterized in that the at least one polysiloxane can be represented by the general formula (I) 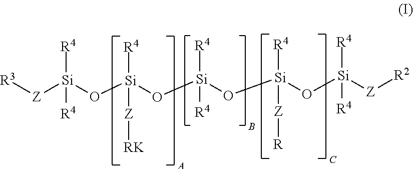
where
Z=independently of one another, C₁-C₆-alkylene, where substituents Z bonded to the radicals R or RK are, independently of one another, C₃-C₆-alkylene, preferably propylene,
RK=unbranched polyether radical of alkylene oxide units and/or arylene oxide units, and/or aliphatic radical and/or cycloaliphatic radical, and/or unbranched and aliphatic, cycloaliphatic and/or aromatic polyester radical
R=polyhydroxyfunctional branched polyglycidol polyether radical which consists of a branched polyglycidol group or comprises this, and/or
=polyhydroxyfunctional branched polyoxetane polyether radical which consists of a branched polyoxetane group or comprises this,
R² and R³, independently of one another, are C₁-C₁₄-alkyl, -aryl or -aralkyl, —O(C₁-C₁₄-alkyl, -aryl or -aralkyl), —OCO(C₁-C₁₄-alkyl, -aryl or -aralkyl), —O—CO—O(C₁-C₁₄-alkyl, -aryl or -aralkyl), —H, —OH, —R, —RK,
R⁴=C₁-C₁₄-alkyl, -aryl or -aralkyl,
A=0-4, preferably 0-2, particularly preferably 0 or 1, very particularly preferably 0,
B=0-6, preferably 0-4, particularly preferably 0, 1 or 2, very particularly preferably 0 or 1, and
C=0-6, preferably 1-4, particularly preferably 1 or 2;
where the sum of A+B+C is at most 7, and
where when C=0, R³=R and/or R²=R.

3. The use as claimed in one or more of claims 1-2, characterized in that the (meth)allylic starter compound is reacted with glycidol or glycerol carbonate, preferably with glycidol.

4. The use as claimed in one or more of claims 1-3, characterized in that the Si—H-functional alkylpolysiloxane is a methylpolysiloxane.

5. The use as claimed in one or more of claims 1-4, characterized in that at least one mono-hydroxyfunctional allylic starter compound from the group consisting of allyl alcohol, ethylene glycol monoallyl ether, allyl polyethylene glycol, allyl polypropylene glycol and allyl polyethylene/propylene glycol mixed polymers, where ethylene oxide and propylene oxide can be arranged in random structure or blockwise, is used as (meth)allylic starter compound having at least one hydrogen-active group.

6. The use as claimed in one or more of claims 1-5, characterized in that at least one allylic starter compound having 2 hydroxy groups, preferably trimethylolpropane monoallyl ether or glycerol monoallyl ether, is used as (meth)allylic starter compound having at least one hydrogen-active group.

7. The use as claimed in one or more of claims 1-6, characterized in that the (meth)allyl polyether has at least two branching generations.

8. The use as claimed in one or more of claims 1-7, characterized in that at least one hydroxyoxetane selected from the group consisting of 3-methyl-3-(hydroxymethyl)oxetane, 3-ethyl-3-(hydroxy-methyl)oxetane and 3,3-di(hydroxymethyl)oxetane (trimethylolpropane oxetane), is used as hydroxyoxetane.

9. The use as claimed in one or more of claims 1-8, characterized in that the polyether-modified polyhydroxyfunctional polysiloxane consists of 3 to 9 siloxane units.

10. The use as claimed in one or more of claims 2-9, characterized in that the radical R is composed to at least 50 mol %, particularly preferably to at least 70 mol % and very particularly preferably to at least 90 mol % of the radical R, of glycidol radicals.

11. The use as claimed in one or more of claims 1-10, characterized in that the free hydroxy groups of the (meth)allyl polyether are alkoxylated.

12. A thermoplastic or polymeric molding composition, comprising at least one polyether-modified polyhydroxyfunctional polysiloxane preparable by
i) firstly reacting at least one (meth)allylic starter compound having at least one hydrogen-active group with at least one reagent selected from the group consisting of glycidol, glycerol carbonate and hydroxyoxetanes such that, with ring opening, at least one (meth)allyl polyether is formed which comprises at least one branched polyglycidol radical and/or at least one branched polyoxetane radical, and then
ii) adding the (meth)allyl polyether(s) obtained in the presence of an acid-buffering agent onto an Si—H-functional alkylpolysiloxane.

13. The thermoplastic or polymeric molding composition as claimed in claim 12, characterized in that the at least one polysiloxane can be represented by the general formula (I) 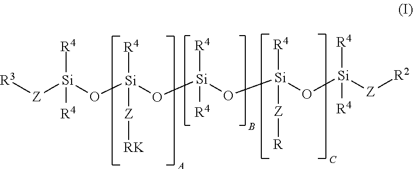
where
Z=independently of one another, C₁-C₆-alkylene, where substituents Z bonded to the radicals R or RK are, independently of one another, C₃-C₆-alkylene, preferably propylene,
RK=unbranched polyether radical of alkylene oxide units and/or arylene oxide units, and/or aliphatic radical and/or cycloaliphatic radical, and/or unbranched and aliphatic, cycloaliphatic and/or aromatic polyester radical
R=polyhydroxyfunctional branched polyglycidol polyether radical which consists of a branched polyglycidol group or comprises this, and/or
=polyhydroxyfunctional branched polyoxetane polyether radical which consists of a branched polyoxetane group or comprises this,
R² and R³, independently of one another, are C₁-C₁₄-alkyl, -aryl or -aralkyl, —O(C₁-C₁₄-alkyl, -aryl or -aralkyl), —OCO(C₁-C₁₄-alkyl, -aryl or -aralkyl), —O—CO—O(C₁-C₁₄-alkyl, -aryl or -aralkyl), —H, —OH, —R, —RK,
R⁴═C₁-C₁₄-alkyl, -aryl or -aralkyl,
A=0-4, preferably 0-2, particularly preferably 0 or 1, very particularly preferably 0,
B=0-6, preferably 0-4, particularly preferably 0, 1 or 2, very particularly preferably 0 or 1, and
C=0-6, preferably 1-4, particularly preferably 1 or 2;
where the sum of A+B+C is at most 7, and
where when C=0, R³=R and/or R²=R.

14. The thermoplastic or polymeric molding composition as claimed in one or more of claims 12-13, characterized in that the at least one polysiloxane is present in a fraction of 0.1-10% by weight, based on the resulting thermoplastic or the resulting molding composition.

15. A method for increasing the surface energy of thermoplastics or polymeric molding compositions, characterized in that prior to the polymerization, 0.1-10% by weight, based on the resulting thermoplastic or the resulting molding composition, of at least one polyether-modified polyhydroxyfunctional polysiloxane preparable by
i) firstly reacting at least one (meth)allylic starter compound having at least one hydrogen-active group with at least one reagent selected from the group consisting of glycidol, glycerol carbonate and hydroxyoxetanes such that, with ring opening, at least one (meth)allyl polyether is formed which comprises at least one branched polyglycidol radical and/or at least one branched polyoxetane radical, and then
ii) adding the (meth)allyl polyether(s) obtained in the presence of an acid-buffering agent onto an Si—H-functional alkylpolysiloxane, are added to the thermoplastic or to the polymeric molding composition.

16. A polyether-modified polyhydroxyfunctional polysiloxane, characterized in that it can be represented by the general formula (I) 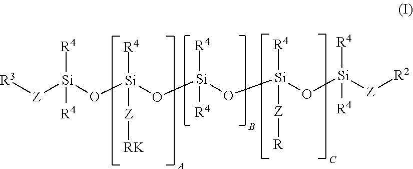
where
Z=independently of one another, C₁-C₆-alkylene, where substituents Z bonded to the radicals R or RK are, independently of one another, C₃-C₆-alkylene, preferably propylene,
RK=unbranched polyether radical of alkylene oxide units and/or arylene oxide units, and/or aliphatic radical and/or cycloaliphatic radical, and/or unbranched and aliphatic, cycloaliphatic and/or aromatic polyester radical
R=polyhydroxyfunctional branched polyglycidol polyether radical which consists of a branched polyglycidol group or comprises this, and/or
=polyhydroxyfunctional branched polyoxetane polyether radical which consists of a branched polyoxetane group or comprises this,
R² and R³, independently of one another, are C₁-C₁₄-alkyl, -aryl or -aralkyl, —O(C₁-C₁₄-alkyl, -aryl or -aralkyl), —OCO(C₁-C₁₄-alkyl, -aryl or -aralkyl), —O—CO—O(C₁-C₁₄-alkyl, -aryl or -aralkyl), —H, —OH, —R, —RK,
R⁴═C₁-C₁₄-alkyl, -aryl or -aralkyl,
A=0-4, preferably 0-2, particularly preferably 0 or 1, very particularly preferably 0,
B=0-6, preferably 0-4, particularly preferably 0, 1 or 2, very particularly preferably 0 or 1, and
C=0-6, preferably 1-4, particularly preferably 1 or 2;
where the sum of A+B+C is at most 7, and
where when C=0, R³=R and/or R²=R.
